(19) United States
(12) Patent Application Publication
(10) Pub. No.: US 2025/0036482 A1
(43) Pub. Date: Jan. 30, 2025

(54) Cloud Content Load Balancing Based On Clean Energy Metrics

(71) Applicant: Cisco Technology, Inc., San Jose, CA (US)

(72) Inventors: Robert Barton, Richmond (CA); Indermeet Gandhi, San Jose, CA (US)

(21) Appl. No.: 18/358,533

(22) Filed: Jul. 25, 2023

(51) Int. Cl. G06F 9/50

(52) U.S. Cl. CPC G06F 9/5083

(57) ABSTRACT

Described herein are devices, systems, methods, and processes for energy-efficient routing in a cloud environment. The system includes a load balancer that distributes incoming traffic across multiple application instances hosted within different availability zones (AZs) based on a preference for sustainable energy sources as communicated by a client device. The client device communicates its preference for sustainable energy sources through a sustainability flag included in a service request. The load balancer steers the service request to the suitable resource based on the sustainability flag. In subsequent interactions, the client device can send a service request with a configuration, such as a sticky cookie. The configuration may allow the load balancer to consistently direct requests from the same client device to the same resource. Accordingly, the embodiments enable energy-efficient routing, client preference for sustainable energy, and consistent service, and contribute to environmental protection.

The present disclosure relates to cloud computing. More particularly, the present disclosure relates to routing traffic in multi-availability zone (multi-AZ) deployments based on energy efficiency and renewable energy sources.

### BACKGROUND

In the field of cloud computing, high availability and fault tolerance are important aspects of application and service deployment. One common approach to achieving high availability is through the use of multi-availability zone (multi-AZ) deployments. In such deployments, applications or services are distributed across multiple, physically separate data centers (e.g., AZs) within a single region. These AZs are connected via low latency networks, allowing for seamless failover and load balancing in case of disruptions or failures in one of the zones.

However, as organizations become increasingly concerned about their environmental impact and strive to achieve net-zero goals, the energy efficiency and renewable energy sources of the data centers powering these multi-AZ deployments have become important considerations. Different AZs within a region may rely on varying energy sources, with some utilizing renewable energy while others depend on a mix of renewable and non-renewable sources. This variation in energy sources can lead to differences in the net-zero and greenhouse gas emission profiles of the AZs.

Current load balancing solutions, such as application load balancers (ALBs), primarily focus on distributing incoming traffic across multiple instances of an application running in different AZs based on performance and availability metrics. As a result, organizations seeking to minimize their environmental impact and achieve net-zero goals may face challenges in ensuring that their cloud-based applications and services are utilizing the energy-efficient and sustainable AZs.

### SUMMARY OF THE DISCLOSURE

Systems and methods for routing traffic in multi-availability zone (multi-AZ) deployments based on energy efficiency and renewable energy sources in accordance with embodiments of the disclosure are described herein. In some embodiments, a network node, includes a processor, at least one network interface controller configured to provide access to a network, and a memory communicatively coupled to the processor, wherein the memory includes a load balancing with sustainability logic. The load balancing with sustainability logic is configured to receive a service request from a client device, including a sustainability flag, identify sustainability data associated with a plurality of computing resources, select one or more computing resources in the plurality of computing resources based on the sustainability flag and the identified sustainability data, and direct the service request to be served by the selected one or more computing resources.

In some embodiments, the sustainability flag is included in a message header of the service request.

In some embodiments, the load balancing with sustainability logic is further configured to receive one or more updates for the sustainability data associated with the plurality of computing resources.

In some embodiments, the load balancing with sustainability logic is further configured to: generate a configuration for the client device, the configuration associating the client device with the selected one or more computing resources; and transmit the configuration to the client device.

In some embodiments, the configuration is associated with a cookie.

In some embodiments, the load balancing with sustainability logic is further configured to: receive at least one subsequent service request from the client device, the at least one subsequent service request being associated with the configuration; and direct the at least one subsequent service request to be served by the selected one or more computing resources based on the configuration.

In some embodiments, each of the plurality of computing resources corresponds to at least one of an availability zone (AZ), a point of presence (POP), or a network device.

In some embodiments, the sustainability data includes at least one environmental impact metric for each of the plurality of computing resources.

In some embodiments, the sustainability flag indicates a presence or an absence of a sustainability preference of the client device.

In some embodiments, the one or more computing resources are selected based on at least one environmental impact metric for the selected one or more computing resources being less than a first threshold in response to the sustainability flag indicating the presence of the sustainability preference of the client device.

In some embodiments, the sustainability flag indicates a degree of a sustainability preference of the client device.

In some embodiments, the one or more computing resources are selected based on at least one environmental impact metric for the selected one or more computing resources being less than a first threshold in response to the degree of the sustainability preference of the client device as indicated by the sustainability flag being greater than a second threshold.

In some embodiments, a client device, includes a processor, at least one network interface controller configured to provide access to a network, and a memory communicatively coupled to the processor, wherein the memory includes a sustainability logic that is configured to transmit a service request to a network node, wherein the service request including a sustainability flag. The logic is further configured to receive at least one service response from one or more computing resources in a plurality of computing resources based on the service request including the sustainability flag.

In some embodiments, the sustainability flag is included in a message header of the service request.

In some embodiments, the sustainability logic is further configured to receive a configuration from the network node, the configuration associating the client device with the one or more computing resources.

In some embodiments, the configuration is associated with a cookie.

In some embodiments, the sustainability logic is further configured to transmit at least one subsequent service request to the network node, the at least one subsequent service request being associated with the configuration and receive at least one subsequent service response from the one or more computing resources based on the configuration.

In some embodiments, the sustainability logic is further configured to delete the configuration at the client device in response to a service quality associated with the one or more computing resources being less than a threshold.

In some embodiments, the sustainability flag indicates at least one of a presence, an absence, or a degree of a sustainability preference of the client device.

In some embodiments, a method for load balancing with sustainability, includes receiving a service request from a client device, the service request including a sustainability flag, identifying sustainability data associated with a plurality of computing resources, selecting one or more computing resources in the plurality of computing resources based on the sustainability flag and the identified sustainability data, and directing the service request to be served by the selected one or more computing resources.

Other objects, advantages, novel features, and further scope of applicability of the present disclosure will be set forth in part in the detailed description to follow, and in part will become apparent to those skilled in the art upon examination of the following or may be learned by practice of the disclosure. Although the description above contains many specificities, these should not be construed as limiting the scope of the disclosure but as merely providing illustrations of some of the presently preferred embodiments of the disclosure. As such, various other embodiments are possible within its scope. Accordingly, the scope of the disclosure should be determined not by the embodiments illustrated, but by the appended claims and their equivalents.

### BRIEF DESCRIPTION OF DRAWINGS

The above, and other, aspects, features, and advantages of several embodiments of the present disclosure will be more apparent from the following description as presented in conjunction with the following several figures of the drawings.

FIG. 1 is a schematic diagram of a network with network devices powered by various power source types in accordance with an embodiment of the disclosure;

FIG. 2 is a diagram illustrating a cloud environment with energy-efficient routing in accordance with various embodiments of the disclosure;

FIG. 3 is a diagram illustrating a client device interacting with a load balancer and resources in accordance with various embodiments of the disclosure;

FIG. 4 is a flowchart showing a process for energy-efficient routing in a cloud environment in accordance with various embodiments of the disclosure;

FIG. 5 is a flowchart showing a process for energy-efficient routing in a cloud environment in accordance with various embodiments of the disclosure;

FIG. 6 is a flowchart showing a process for configuring a client device for energy-efficient routing in a cloud environment in accordance with various embodiments of the disclosure;

FIG. 7 is a flowchart showing a process for transmitting a service request based on a sustainability preference in a cloud environment in accordance with various embodiments of the disclosure;

FIG. 8 is a flowchart showing a process for transmitting a service request based on a sustainability preference in a cloud environment in accordance with various embodiments of the disclosure;

FIG. 9 is a flowchart showing a process for transmitting a service request based on a sustainability preference in a cloud environment in accordance with various embodiments of the disclosure; and

FIG. 10 a conceptual block diagram for one or more devices capable of executing components and logic for implementing the functionality and embodiments described above.

Corresponding reference characters indicate corresponding components throughout the several figures of the drawings. Elements in the several figures are illustrated for simplicity and clarity and have not necessarily been drawn to scale. For example, the dimensions of some of the elements in the figures might be emphasized relative to other elements for facilitating understanding of the various presently disclosed embodiments. In addition, common, but well-understood, elements that are useful or necessary in a commercially feasible embodiment are often not depicted in order to facilitate a less obstructed view of these various embodiments of the present disclosure.

### DETAILED DESCRIPTION

In response to the issues described above, devices and methods are discussed herein that may facilitate energy-efficient routing in multi-availability zone (multi-AZ) deployments by taking into account the energy efficiency and renewable energy sources of the AZs when distributing traffic. In many embodiments, existing load balancing processes may be enhanced with a relative weighting system that can reflect the greenhouse gas (GHG)/net-zero compliance of each AZ. The weighting system may be monitored and used to influence the global AZ load balancing process, directing traffic to the energy-efficient and sustainable AZs when feasible.

In a number of embodiments, organizations with clean energy or net-zero policies can utilize an information technology (IT) net-zero system to guide which cloud points of presence (POPs) or AZs their client applications access, aiming to reduce GHG emissions. The IT GHG monitoring system can be linked with agents running on client machines and may use policies to influence how the client devices access resources that contribute to achieving net-zero or energy-efficient cloud systems. In a variety of embodiments, when a client device or endpoint is configured with a clean energy or GHG net-zero policy, a clean energy preference flag (which may be referred to interchangeably as the sustainability flag hereinafter) can be embedded in a message header (e.g., a hypertext transfer protocol (HTTP) header) field from the browser at the client device or endpoint. As the client device web browser accesses cloud resources, the clean energy preference header field including the sustainability flag can indicate that an energy-efficient POP or AZ is preferable if available. In other words, the sustainability flag may indicate the presence of a clean energy/sustainability preference of the client device. Similarly, the sustainability flag may also indicate the absence of a clean energy/sustainability preference of the client device.

In some embodiments, the client device web browser may connect to an application load balancer (ALB) in the cloud. The ALB can look for the energy efficiency request indicator (e.g., the clean energy preference/sustainability flag) (e.g., by examining the incoming HTTP header fields). If the indicator/flag is set, the ALB may attempt to direct incoming traffic to the POP or AZ with the most appropriate energy efficiency/clean energy score (e.g., a POP or AZ with an energy efficiency/clean energy/environmental impact score/metric that meets or exceeds a threshold). In more embodiments, the clean energy/sustainability flag (e.g., in the HTTP header) may be on a graduated scale (e.g., on a scale of 1-100), providing the ALB or local load balancer with a relative weighting of how important clean energy POPs/AZs are to the client device or endpoint. The ALB can use this data to balance the importance of clean energy with other factors such as, but not limited to, performance and server load.

In additional embodiments, if session stickiness is enabled, a cookie setting can be configured to ensure that the same client is routed to the same POP or AZ. The cookie may contain the instance identifier (ID) of the POP or AZ where the client's session is being served. In particular, the ALB can insert a session stickiness cookie into the browser at the client device to ensure that future requests from the same client are directed to the same clean energy POP or AZ.

In further embodiments, as the user or client makes subsequent requests to the ALB, the cookie may be included in the request. The ALB can use the cookie to identify the instance that is serving the client's session and can route the request to that instance. However, in still more embodiments, if performance degrades at the current POP or AZ, a management system (e.g., the mobile device management (MDM) system at the client device) that is monitoring the performance may clear the stickiness cookie and may make a new connection to the ALB without the clean energy preference flag set.

In still further embodiments, where local load balancers are used in a data center, the content load balancer can examine the incoming clean energy preference field (e.g., the sustainability flag) and can attempt to steer the connection to the backend server with the most appropriate energy efficiency/environmental impact profile metrics. By way of a non-limiting example, the local load balancer may connect to the servers with the best energy efficiency profile. Cookie-based session stickiness and the energy efficiency preferences incorporated into the routing process may ensure that client sessions are consistently served from the most appropriate POPs or AZs. The environmental impact of cloud-based applications and services can be reduced as a result.

Aspects of the present disclosure may be embodied as an apparatus, system, method, or computer program product. Accordingly, aspects of the present disclosure may take the form of an entirely hardware embodiment, an entirely software embodiment (including firmware, resident software, micro-code, or the like) or an embodiment combining software and hardware aspects that may all generally be referred to herein as a “function,” “module,” “apparatus,” or “system.” Furthermore, aspects of the present disclosure may take the form of a computer program product embodied in one or more non-transitory computer-readable storage media storing computer-readable and/or executable program code. Many of the functional units described in this specification have been labeled as functions, in order to emphasize their implementation independence more particularly. For example, a function may be implemented as a hardware circuit comprising custom very large-scale integration (VLSI) circuits or gate arrays, off-the-shelf semiconductors such as logic chips, transistors, or other discrete components. A function may also be implemented in programmable hardware devices such as via field programmable gate arrays, programmable array logic, programmable logic devices, or the like.

Functions may also be implemented at least partially in software for execution by various types of processors. An identified function of executable code may, for instance, comprise one or more physical or logical blocks of computer instructions that may, for instance, be organized as an object, procedure, or function. Nevertheless, the executables of an identified function need not be physically located together but may comprise disparate instructions stored in different locations which, when joined logically together, comprise the function and achieve the stated purpose for the function.

Indeed, a function of executable code may include a single instruction, or many instructions, and may even be distributed over several different code segments, among different programs, across several storage devices, or the like. Where a function or portions of a function are implemented in software, the software portions may be stored on one or more computer-readable and/or executable storage media. Any combination of one or more computer-readable storage media may be utilized. A computer-readable storage medium may include, for example, but not limited to, an electronic, magnetic, optical, electromagnetic, infrared, or semiconductor system, apparatus, or device, or any suitable combination of the foregoing, but would not include propagating signals. In the context of this document, a computer readable and/or executable storage medium may be any tangible and/or non-transitory medium that may contain or store a program for use by or in connection with an instruction execution system, apparatus, processor, or device.

Computer program code for carrying out operations for aspects of the present disclosure may be written in any combination of one or more programming languages, including an object-oriented programming language such as Python, Java, Smalltalk, C++, C#, Objective C, or the like, conventional procedural programming languages, such as the “C” programming language, scripting programming languages, and/or other similar programming languages. The program code may execute partly or entirely on one or more of a user's computer and/or on a remote computer or server over a data network or the like.

A component, as used herein, comprises a tangible, physical, non-transitory device. For example, a component may be implemented as a hardware logic circuit comprising custom VLSI circuits, gate arrays, or other integrated circuits; off-the-shelf semiconductors such as logic chips, transistors, or other discrete devices; and/or other mechanical or electrical devices. A component may also be implemented in programmable hardware devices such as field programmable gate arrays, programmable array logic, programmable logic devices, or the like. A component may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may alternatively be embodied by or implemented as a component.

A circuit, as used herein, comprises a set of one or more electrical and/or electronic components providing one or more pathways for electrical current. In certain embodiments, a circuit may include a return pathway for electrical current, so that the circuit is a closed loop. In another embodiment, however, a set of components that does not include a return pathway for electrical current may be referred to as a circuit (e.g., an open loop). For example, an integrated circuit may be referred to as a circuit regardless of whether the integrated circuit is coupled to ground (as a return pathway for electrical current) or not. In various embodiments, a circuit may include a portion of an integrated circuit, an integrated circuit, a set of integrated circuits, a set of non-integrated electrical and/or electrical components with or without integrated circuit devices, or the like. In one embodiment, a circuit may include custom VLSI circuits, gate arrays, logic circuits, or other integrated circuits; off-the-shelf semiconductors such as logic chips, transistors, or other discrete devices; and/or other mechanical or electrical devices. A circuit may also be implemented as a synthesized circuit in a programmable hardware device such as field programmable gate array, programmable array logic, programmable logic device, or the like (e.g., as firmware, a netlist, or the like). A circuit may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may be embodied by or implemented as a circuit.

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to”, unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Further, as used herein, reference to reading, writing, storing, buffering, and/or transferring data can include the entirety of the data, a portion of the data, a set of the data, and/or a subset of the data. Likewise, reference to reading, writing, storing, buffering, and/or transferring non-host data can include the entirety of the non-host data, a portion of the non-host data, a set of the non-host data, and/or a subset of the non-host data.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps, or acts are in some way inherently mutually exclusive.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding embodiments. For instance, an arrow may indicate a waiting or monitoring period of unspecified duration between enumerated steps of the depicted embodiment.

In the following detailed description, reference is made to the accompanying drawings, which form a part thereof. The foregoing summary is illustrative only and is not intended to be in any way limiting. In addition to the illustrative aspects, embodiments, and features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

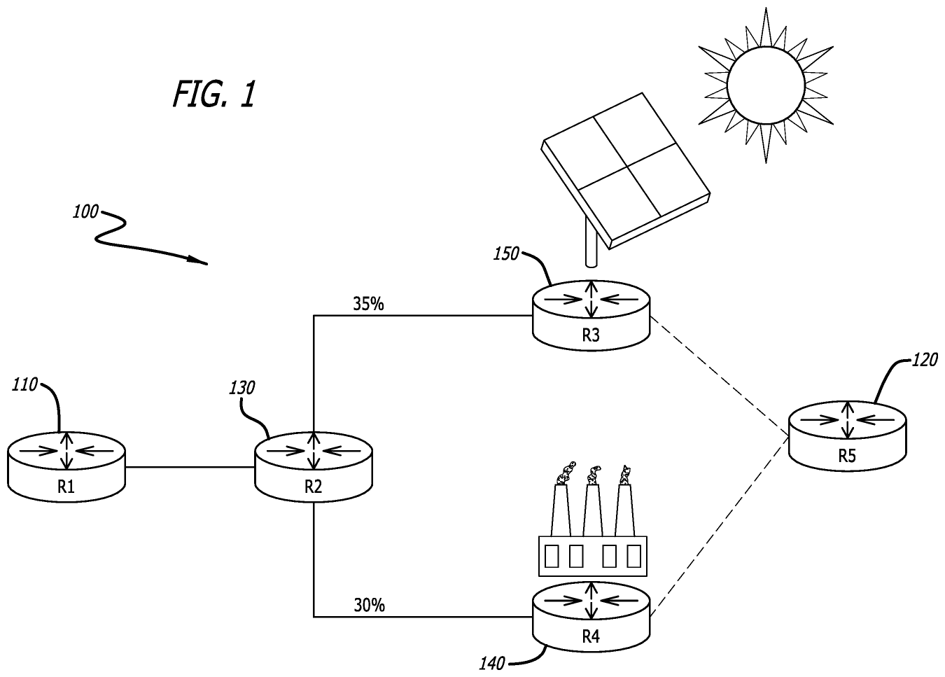

Referring to FIG. 1, a schematic diagram of a network 100 with network devices powered by various power source types in accordance with an embodiment of the disclosure is shown. The network 100 can include a plurality of devices, e.g., routers 110, 130, 140 and 150, which can be in communication with each other and/or a remote server, such as a cloud-based server 120. The network 100 depicted in FIG. 1 is shown as a simplified, conceptual network. Those skilled in the art will understand that a network 100 can include a large variety of devices and be arranged in a virtually limitless number of combinations based on the desired application and available deployment environment.

Additionally, it is recognized that the terms “power” and “energy” are often used interchangeably in many colloquial settings but have distinct differences. Specifically, energy is accepted as the capacity of a system or device to do work (such as in kilowatt-hours (kWh)), while power is the rate at which energy is transferred (often in watts (W)). Power represents how fast energy is being used or produced. With this in mind, it should be understood that various elements of the present disclosure may utilize common terms like “power lines,” “power grids,” power source,” “power consumption,” and “power plant” when describing energy delivery and utilization, even though those skilled in the art will recognize that those elements are delivering or processing energy (specifically electricity) at a certain rate of power. References to these terms are utilized herein specifically to increase the ease of reading.

Traditionally, devices operating within a network 100 have not considered various aspects of operation that can relate to the overall sustainability of the network. For example, devices in communication networks have often used grid-supplied energy as a primary power source. This grid-supplied energy can regularly provide energy that has been generated by a negative environmental impacts-heavy power source such as a coal-powered power plant. However, modern power grids often have more diverse and cleaner energy sources for the provided generated energy. Some devices can still be powered by power sources that utilize fossil fuels, such as the router R4 140 as depicted in FIG. 1. Alternatively, some devices can operate by using renewable sources of energy, such as the router R3 150 which is conceptually depicted as being powered by solar power.

Those skilled in the art will recognize that the generation of electricity within the various power plants often creates some pollution or, more generally, one or more negative environmental impacts, which can often come in the form of emissions. However, these negative environmental impacts can come in a variety of forms including, but not limited to, land use, ozone depletion, ozone formation inhibition, acidification, eutrophication (freshwater, marine, and terrestrial), abiotic resource depletion (minerals, metals, and fossil fuels), toxicity, water use, negative soil quality change, ionizing radiation, hazardous waste creation, etc. As such, these negative environmental impact measurements can be measured with specific units to quantify these changes. Various aspects of energy use can be associated with one or more of these negative environmental impacts and classified as one or more sustainability-related attributes.

In the embodiment depicted in FIG. 1, the operation of a coal-powered power plant will create a sizeable amount of negative environmental impacts in the form of carbon emissions and the like. Contrast that with a solar array which may not create emissions when generating electricity, but may negative environmental impacts, such as carbon emission generation, associated with the production and/or disposal of the solar array. Various methods of measuring these negative environmental impacts may occur. One measurement may be to examine the waste products created by the power generated (such as nuclear waste, vs. solar array e-waste, etc.).

Another measurement of negative environmental impacts that can be utilized when comparing power sources is to determine the amount of greenhouse or carbon emissions released per unit of electricity generated. Specifically, various embodiments described herein may utilize the CO₂e kg/kWh metric which measure the amount of kilowatt hours produced per kilogram of carbon dioxide gases released into the environment. Therefore, when discussing a negative environmental impacts-heavy power source compared to a clean(er) power source, the clean power source can, for example, have a better CO₂e kg/kWh rating compared to the negative environmental impacts-heavy power source. Utilizing a cleaner power source thus provides for a more sustainable network operation.

In order the maximize the overall sustainability of a network, it may be desirable to increase the use of cleaner power sources with a lower overall negative environmental impact as opposed to power sources with a higher overall negative environmental impact when operating the network. Thus, there can be a need to be aware of the source of energy provided at each device along the route of data travel. Additionally, other factors such as the attributes unique to each device can be factored in, along with the current and/or expected traffic, etc. Once known, an optimal method of traversing the data may need to be calculated. As discussed in more detail, this path algorithm can be utilized to better optimize the locations selected within a network for data travel.

Other methods may be utilized to increase sustainability in network operations. In many embodiments, the network devices themselves may have one or more features or other capabilities that can allow for a more efficient operation. For example, a network router may be operated in a lower power mode or be powered off entirely for a specific period of time or until an event occurs. Additional embodiments may utilize various other power-saving capabilities that can be turned on or off remotely or in response to an event or predetermined threshold being exceeded. Often, operations performed by the network devices can be utilized in scenarios where network performance will not be affected or is affected such that no loss in user experience occurs. By utilizing less power during operation, a higher level of sustainability can be achieved.

Together, the type of power source providing electricity to a network device, along with the various sustainability-related capabilities of the router can be understood as the sustainability-related attributes of that network device. During operation, one or more devices within the network may seek and collect the sustainability-related attributes of various network devices, which can provide insight into both the type of power source providing power to the device, but also the various capabilities of the network device that may be activated to provide more efficient operation.

Additionally, when generating various scores, metrics, or other evaluations of the network devices within a network 100, the sustainability-related attributes can vary based on a variety of factors such as the time of day, current network traffic, expected network traffic, and historical usage patterns. For example, a network router may receive energy from a solar power source during the day but receives energy from a coal-powered power plant at night. In these instances, an averaged score may be used, or a unique score may be generated at the time of operation. In another example, network traffic may be such that removing one or more network devices from the optimal sustainable data paths may negatively affect user experiences, such as when a sporting event occurs. As such, scores may be generated at numerous times depending on the desired application. Often, the act of measurement may negatively affect sustainability such that determining the proper amount of measurements for a given outcome may be determined.

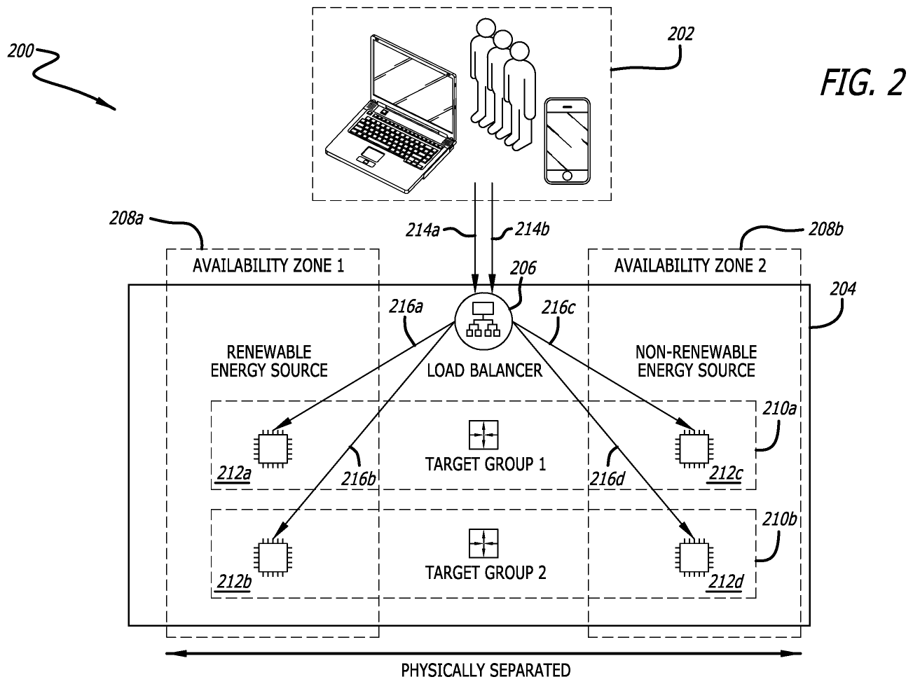

Although a specific embodiment for a network 100 is described above with respect to FIG. 1, any of a variety of systems and/or processes may be utilized in accordance with embodiments of the disclosure. For example, the network could be broken into a plurality of partitions, wherein each partition could have specific needs, service level agreements, etc. that can alter sustainability-optimization. The elements depicted in FIG. 1 may also be interchangeable with other elements of FIGS. 2-10 as required to realize a particularly desired embodiment. Augmented protocols to carry out these described processes are described below.

Referring to FIG. 2, a diagram illustrating a cloud environment 200 with energy-efficient routing in accordance with various embodiments of the disclosure is shown. In many embodiments, the cloud environment may include multiple AZs, application instances, and a load balancer (e.g., an ALB). In a number of embodiments, the cloud environment can be divided into different regions, with the depicted region being region 204. As shown in the embodiment depicted in FIG. 2, within this region 204, there may be two AZs, AZ 1 208a and AZ 2 208b, which are physically separated from each other. In a variety of embodiments, AZ 1 208a may be powered by renewable energy sources, while AZ 2 208b can be powered by non-renewable energy sources.

In some embodiments, the application instances may be hosted within these AZs. Specifically, application instances 212a and 212b are hosted at AZ 1 208a, and application instances 212c and 212d are hosted at AZ 2 208b. In more embodiments, the application instances may be grouped into target groups (e.g., logical grouping of instances within an AZ). As shown in the embodiment depicted in FIG. 2, application instances 212a and 212c may be within target group 1 210a, while application instances 212b and 212d may be within target group 2 210b.

In additional embodiments, the region 204 can also include a load balancer 206, which may be responsible for distributing incoming traffic across multiple application instances to ensure that no single instance is overwhelmed with requests. The load balancer 206 can take into account the clean energy preference flag set in the access requests sent by client devices 202. In further embodiments, when the client devices 202 send access requests 214a with a clean energy preference flag set, the load balancer 206 may steer such traffic to either instance 212a or 212b in AZ 1 208a, which is powered by renewable energy sources. Conversely, when the access requests 214b do not have a clean energy preference flag set (or have a negative clean energy preference flag set), the load balancer 206 can steer such traffic to instances 212c or 212d in AZ 2 208b, which is powered by non-renewable energy sources.

Although a specific embodiment for a cloud environment with energy-efficient routing suitable for carrying out the various steps, processes, methods, and operations described herein is discussed with respect to FIG. 2, any of a variety of systems and/or processes may be utilized in accordance with embodiments of the disclosure. For example, the load balancer may be configured to distribute traffic based on other factors in addition to the clean energy preference flag, such as the current load on each instance or the geographical location of the client devices. The elements depicted in FIG. 2 may also be interchangeable with other elements of FIGS. 1 and 3-10 as required to realize a particularly desired embodiment.

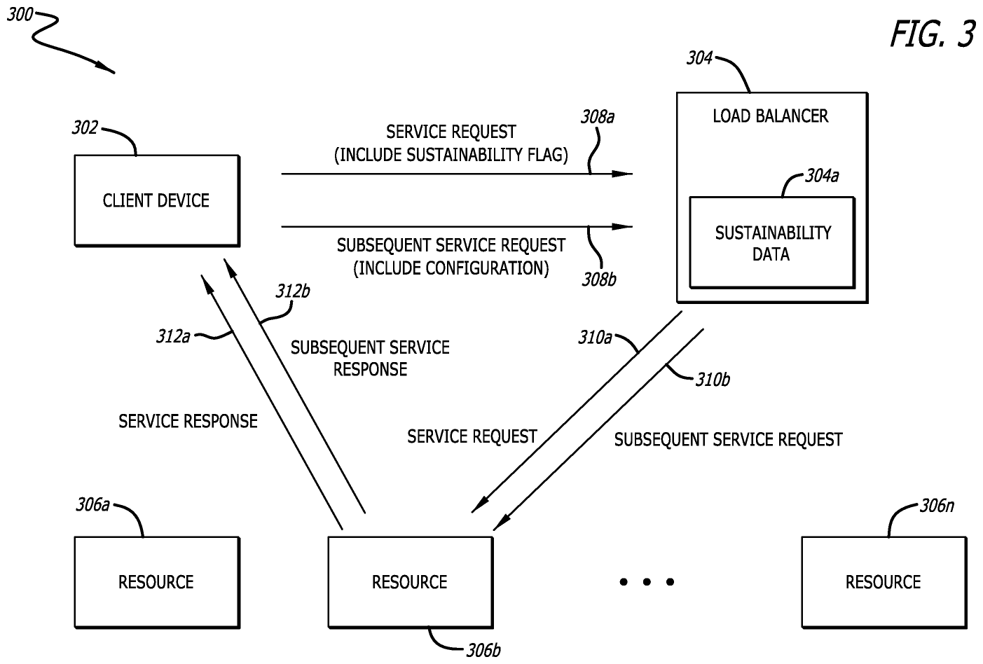

Referring to FIG. 3, a diagram 300 illustrating a client device interacting with a load balancer and resources in accordance with various embodiments of the disclosure is shown. The embodiment depicted in FIG. 3 includes a client device 302, a load balancer 304 with sustainability data 304a, and multiple computing resources (or simply “resources” hereinafter) 306a, 306b, . . . 306n. Each of the computing resources may correspond to, but not limited to, an AZ, a POP, an application instance, a network device, or a server. In many embodiments, the client device 302 may send a service request 308a to the load balancer 304. The service request 308a can include a sustainability flag (e.g., a preference indicator set by the client device 302 to express its preference for resources powered by sustainable or renewable energy sources). The load balancer 304, equipped with sustainability data 304a, can use the sustainability data 304a to determine the energy efficiency or sustainability of each resource. In a number of embodiments, the sustainability data 304a may include data such as the type of energy source powering each resource, the carbon footprint of each resource, or other relevant sustainability (environmental impact) metrics. Based on the sustainability flag in the service request 308a and the sustainability data 304a, the load balancer 304 can steer the service request to the resource 306b. By way of a non-limiting example, if the sustainability flag indicates a (strong) preference for clean energy, the resource 306b selected by the load balancer may be, accordingly, the most sustainable (and/or energy-efficient, etc.) resource available. The steered service request 310a may represent the service request 308a being directed towards resource 306b. The resource 306b then can process the request and can transmit a service response 312a back to the client device 302.

In a variety of embodiments, the client device 302 can send a subsequent service request 308b to the load balancer 304. The subsequent service request 308b may include a configuration. In some embodiments, the configuration may include a cookie (e.g., a sticky cookie) set by the load balancer 304 after the load balancer 304 selected the resource 306b in response to the service request 308a. The cookie may be a piece of data stored on the client device 302 that may help the load balancer 304 identify the resource that previously served the client device 302, ensuring that subsequent requests from the same client device are consistently served from the same resource. Using the configuration in the subsequent service request 308b and the sustainability data 304a, the load balancer 304 can steer the subsequent service request to the resource 306b as well. The steered subsequent service request 310b may represent the subsequent service request 308b being directed towards resource 306b. The resource 306b then can process the subsequent service request and can transmit a subsequent service response 312b back to the client device 302.

Although a specific embodiment for a client device interacting with a load balancer and resources suitable for carrying out the various steps, processes, methods, and operations described herein is discussed with respect to FIG. 3, any of a variety of systems and/or processes may be utilized in accordance with embodiments of the disclosure. For example, the load balancer may be configured to distribute traffic based on the time of day, directing more traffic to resources powered by solar energy during daylight hours and to resources powered by other types of renewable energy during nighttime hours. The elements depicted in FIG. 3 may also be interchangeable with other elements of FIGS. 1, 2, and 4-10 as required to realize a particularly desired embodiment.

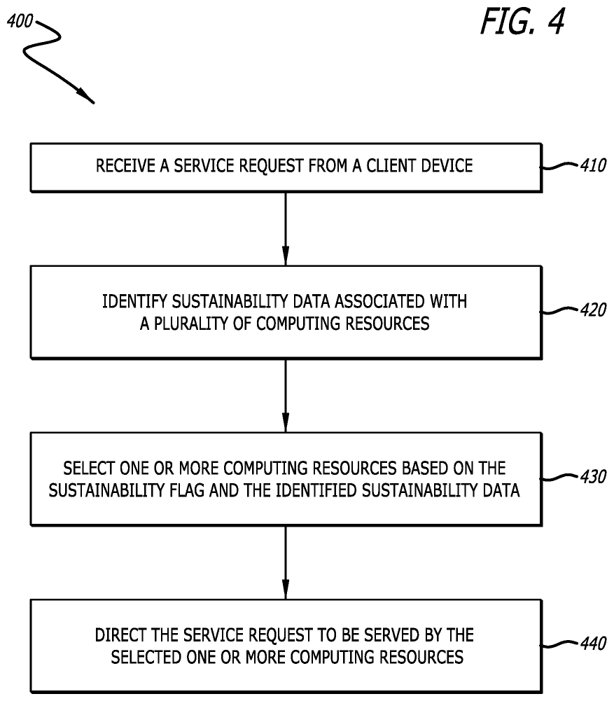

Referring to FIG. 4, a flowchart showing a process 400 for energy-efficient routing in a cloud environment in accordance with various embodiments of the disclosure is shown. In many embodiments, the process 400 may receive a service request from a client device (block 410). The service request can include a sustainability flag (e.g., as or in an HTTP header), which may be a preference indicator set by the client device to express its preference for resources powered by sustainable or renewable energy sources. The service request may be sent over a network, such as the internet, and may be associated with a specific application or service hosted in the cloud.

In a number of embodiments, the process 400 may identify sustainability data associated with a plurality of computing resources (block 420). The sustainability data can relate to the energy efficiency or sustainability of each resource (e.g., an environmental impact metric of each resource). The sustainability data may include, by way of non-limiting examples, the type of energy source powering each resource, the carbon footprint of each resource, or other relevant sustainability/environmental impact metrics.

In a variety of embodiments, the process 400 may select one or more computing resources based on the sustainability flag and the identified sustainability data (block 430). The selection process can include comparing the sustainability data of each resource with the sustainability flag in the service request, and selecting the resource or resources that best match the client device's sustainability preference. The selection can also take into account other factors, such as the current load on each resource, to ensure optimal performance.

In some embodiments, the process 400 may direct the service request to be served by the selected one or more computing resources (block 440). This can include steering the service request to the selected resource or resources. Once the service request is directed to the selected resources, these resources can then process the request and transmit a service response back to the client device.

Although a specific embodiment for energy-efficient routing suitable for carrying out the various steps, processes, methods, and operations described herein is discussed with respect to FIG. 4, any of a variety of systems and/or processes may be utilized in accordance with embodiments of the disclosure. For example, the process may be implemented by different types of network nodes, such as routers or switches, and can involve different types of sustainability data or sustainability flags. The elements depicted in FIG. 4 may also be interchangeable with other elements of FIGS. 1-3 and 5-10 as required to realize a particularly desired embodiment.

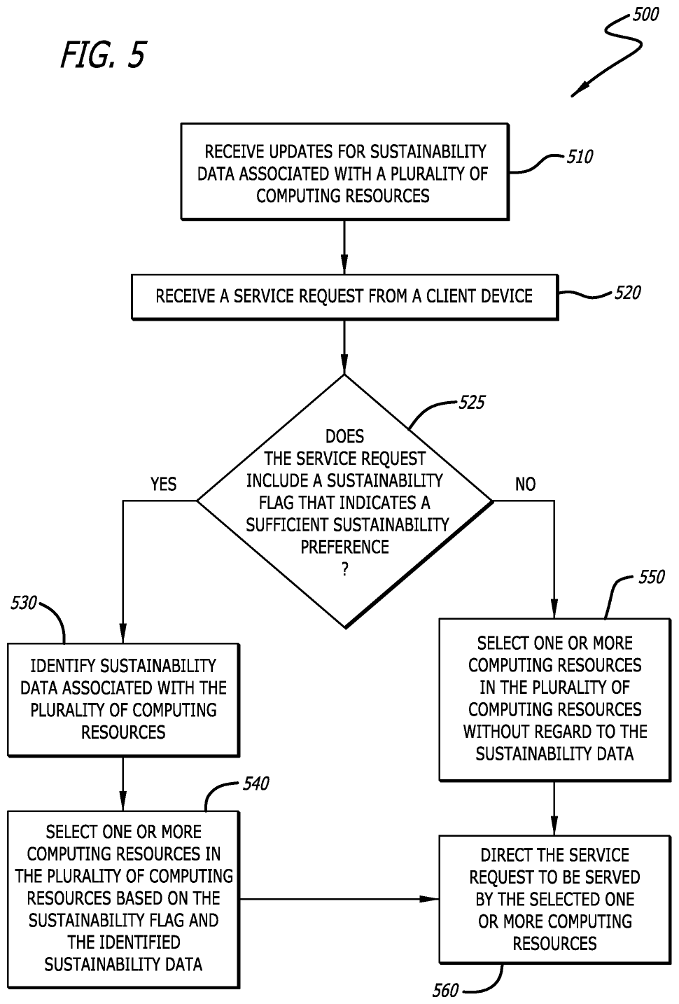

Referring to FIG. 5, a flowchart showing a process 500 for energy-efficient routing in a cloud environment in accordance with various embodiments of the disclosure is shown. In many embodiments, the process 500 may receive updates for sustainability data associated with a plurality of computing resources (block 510). The updates can provide the most recent data about the energy efficiency or sustainability of each resource (e.g., the most recent environmental impact metric of each resource). The updates may be received periodically, or in response to specific events, such as changes in the energy source powering a resource.

In a number of embodiments, the process 500 may receive a service request from a client device (block 520). The service request can include a sustainability flag (e.g., as or in an HTTP header), which may be a preference indicator set by the client device to express its preference for resources powered by sustainable or renewable energy sources. The service request may be sent over a network, such as the internet, and may be associated with a specific application or service hosted in the cloud.

In a variety of embodiments, the process 500 can determine if the service request includes a sustainability flag that indicates a sufficient sustainability preference (block 525). In some embodiments, in response to the service request including a sustainability flag that indicates a sufficient sustainability preference, the process 500 can identify sustainability data associated with the plurality of computing resources. However, in more embodiments, when the service request does not include a sustainability flag that indicates a sufficient sustainability preference, the process 500 can select one or more computing resources in the plurality of computing resources without regard to the sustainability data.

In some embodiments, when the service request includes a sustainability flag that indicates a sufficient sustainability preference, the process 500 may identify sustainability data associated with the plurality of computing resources (block 530). This can include accessing a database or other data storage medium that stores the sustainability data, and retrieving the data associated with each resource. The sustainability data may include, by way of non-limiting examples, the type of energy source powering each resource, the carbon footprint of each resource, or other relevant sustainability/environmental impact metrics.

In more embodiments, the process 500 may select one or more computing resources in the plurality of computing resources based on the sustainability flag and the identified sustainability data (block 540). The selection process can include comparing the sustainability data of each resource with the sustainability flag in the service request, and selecting the resource or resources that best match the client device's sustainability preference. By way of a non-limiting example, based on the comparison, the process 500 can rank the resources and select the resource or resources with the highest compatibility with the sustainability flag.

In additional embodiments, when the service request does not include a sustainability flag that indicates a sufficient sustainability preference, the process 500 can select one or more computing resources in the plurality of computing resources without regard to the sustainability data (block 550). The selection can be based on other factors such as the current load on each resource, the geographical location of the resources, or the type of service requested. This may ensure that even without a sustainability preference, the service request is still efficiently processed.

In further embodiments, the process 500 may direct the service request to be served by the selected one or more computing resources (block 560). This can include steering the service request to the selected resource or resources. Once the service request is directed to the selected resources, the selected resources can then process the request and transmit a service response back to the client device.

Although a specific embodiment for energy-efficient routing suitable for carrying out the various steps, processes, methods, and operations described herein is discussed with respect to FIG. 5, any of a variety of systems and/or processes may be utilized in accordance with embodiments of the disclosure. For example, the process may be implemented by a hybrid cloud environment where the sustainability data is dynamically updated based on real-time energy consumption and renewable energy production data. The elements depicted in FIG. 5 may also be interchangeable with other elements of FIGS. 1-4 and 6-10 as required to realize a particularly desired embodiment.

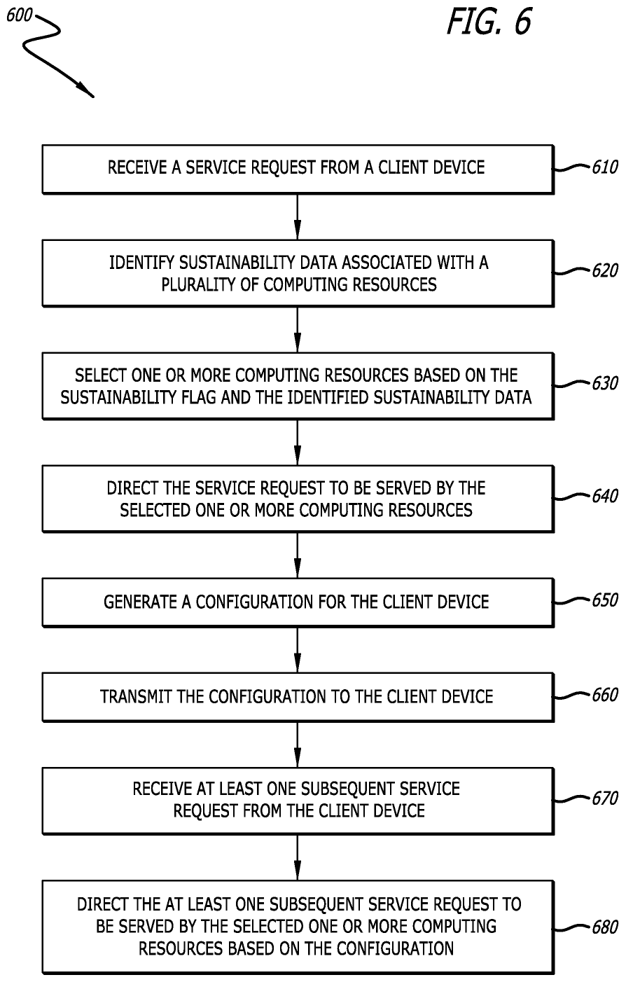

Referring to FIG. 6, a flowchart showing a process 600 for configuring a client device for energy-efficient routing in a cloud environment in accordance with various embodiments of the disclosure is shown. In many embodiments, the process 600 may receive a service request from a client device (block 610). This service request can include a sustainability flag (e.g., as or in an HTTP header), which may be a preference indicator set by the client device. The service request may be sent over a network, such as the internet, and may be associated with a specific application or service hosted in the cloud.

In a number of embodiments, the process 600 may identify sustainability data associated with a plurality of computing resources (block 620). This can include accessing a database or other data storage medium that stores the sustainability data. The sustainability data may include, by way of non-limiting examples, the type of energy source powering each resource, the carbon footprint of each resource, or other relevant sustainability/environmental impact metrics.

In a variety of embodiments, the process 600 may select one or more computing resources in the plurality of computing resources based on the sustainability flag and the identified sustainability data (block 630). The selection process can include comparing the sustainability data of each resource with the sustainability flag in the service request. The process 600 can use a scoring or ranking system to evaluate the compatibility of each resource with the sustainability flag.

In some embodiments, the process 600 may direct the service request to be served by the selected one or more computing resources (block 640). This can include steering the service request to the selected resource or resources. Once the service request is directed to the selected resources, the selected resources can then process the request and transmit a service response back to the client device.

In more embodiments, the process 600 may generate a configuration for the client device (block 650). The configuration can include data about the selected computing resources, such as their addresses or IDs. In additional embodiments, the configuration can be stored as a cookie on the client device.

In further embodiments, the process 600 may transmit the configuration to the client device (block 660). The transmission process can include encoding the configuration into a data packet and sending the data packet over a network to the client device. In still more embodiments, the process 600 may direct the client device to store a cookie that includes the configuration.

In still further embodiments, the process 600 may receive at least one subsequent service request from the client device (block 670). This subsequent service request from the client device can include the configuration. The process 600 can decode the subsequent service request to extract the configuration data.

In still additional embodiments, the process 600 may direct the at least one subsequent service request to be served by the selected one or more computing resources based on the configuration (block 680). This can include steering the subsequent service request to the selected resource or resources. In some more embodiments, the steering process can include modifying the routing data associated with the subsequent service request based on the configuration.

Although a specific embodiment for configuring a client device for energy-efficient routing suitable for carrying out the various steps, processes, methods, and operations described herein is discussed with respect to FIG. 6, any of a variety of systems and/or processes may be utilized in accordance with embodiments of the disclosure. For example, the process may be implemented by a cloud service provider that uses machine learning algorithms to predict the sustainability data of its computing resources based on historical data and current environmental conditions. The elements depicted in FIG. 6 may also be interchangeable with other elements of FIGS. 1-5 and 7-10 as required to realize a particularly desired embodiment.

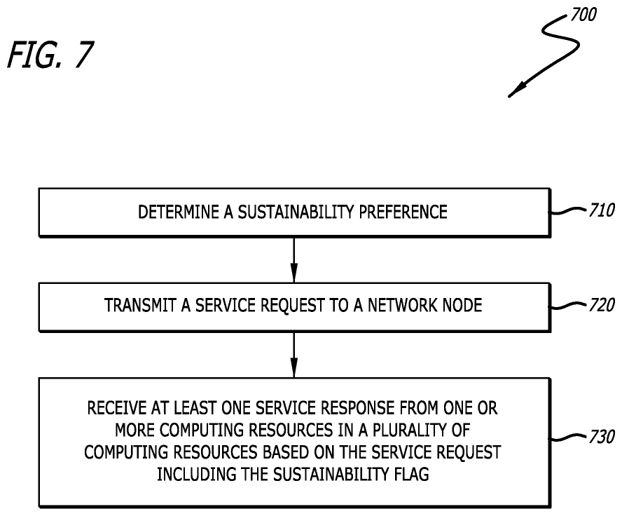

Referring to FIG. 7, a flowchart showing a process 700 for transmitting a service request based on a sustainability preference in a cloud environment in accordance with various embodiments of the disclosure is shown. In many embodiments, the process 700 may determine a sustainability preference (block 710). This can include analyzing user input, system settings, or other data to identify a preference for using computing resources that are powered by sustainable or renewable energy sources. The determination process can include interpreting the user input or system settings and translating them into a sustainability preference.

In a number of embodiments, the process 700 may transmit a service request to a network node (block 720). The service request can include a sustainability flag (e.g., as or in an HTTP header) that indicates the determined sustainability preference and/or the degree of the sustainability preference. The network node can be a server (e.g., a load balancer), router, switch, or other device that is capable of receiving and forwarding the service request.

In a variety of embodiments, the process 700 may receive at least one service response from one or more computing resources in a plurality of computing resources based on the service request including the sustainability flag (block 730). The service response can be generated by the computing resources that were selected to serve the service request based on the sustainability flag. The service response can include data, such as the results of a computation or the contents of a requested web page, that is sent back to the client device.

Although a specific embodiment for transmitting a service request based on a sustainability preference suitable for carrying out the various steps, processes, methods, and operations described herein is discussed with respect to FIG. 7, any of a variety of systems and/or processes may be utilized in accordance with embodiments of the disclosure. For example, the process may be implemented by a client device that uses a web browser or other software application to send service requests over a network. The elements depicted in FIG. 7 may also be interchangeable with other elements of FIGS. 1-6 and 8-10 as required to realize a particularly desired embodiment.

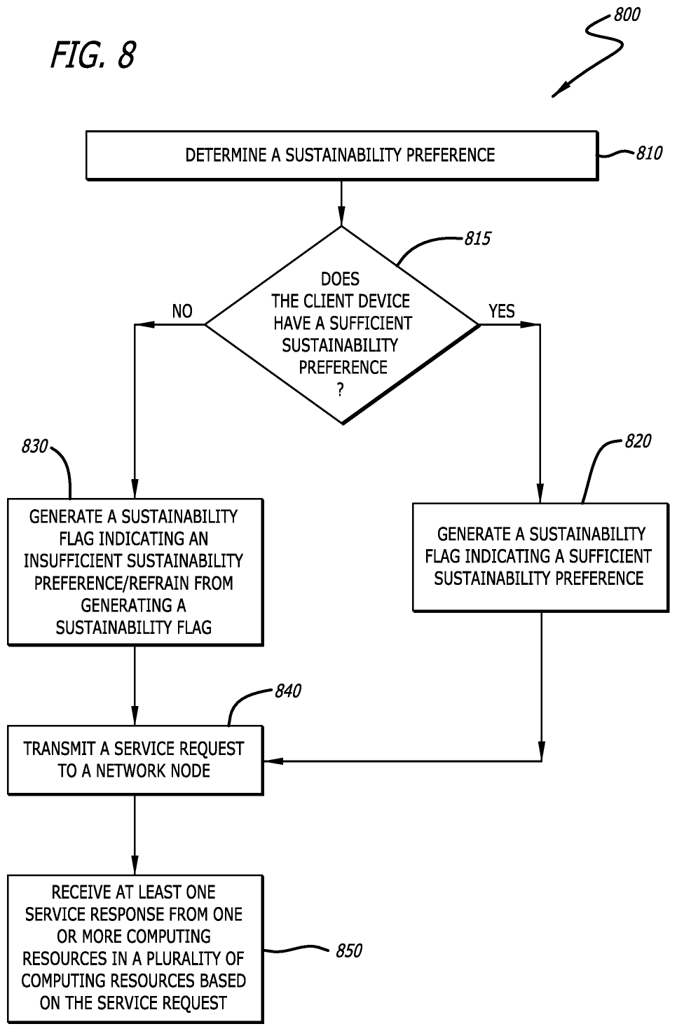

Referring to FIG. 8, a flowchart showing a process 800 for transmitting a service request based on a sustainability preference in a cloud environment in accordance with various embodiments of the disclosure is shown. In many embodiments, the process 800 may determine a sustainability preference (block 810). This can include analyzing user input, system settings, or other data to identify a preference for using computing resources that are powered by sustainable or renewable energy sources. The determination process can include interpreting the user input or system settings and translating them into a sustainability preference.

In a number of embodiments, the process 800 can determine if the client device has a sufficient sustainability preference (block 815). In a variety of embodiments, in response to the client device having a sufficient sustainability preference, the process 800 can generate a sustainability flag indicating a sufficient sustainability preference and/or at least a degree of the sustainability preference. However, in some embodiments, when the client device does not have a sufficient sustainability preference, the process 800 can generate a sustainability flag indicating an insufficient sustainability preference or refrain from generating a sustainability flag.

In more embodiments, if the client device has a sufficient sustainability preference, the process 800 may generate a sustainability flag indicating a sufficient sustainability preference (block 820). The sustainability flag can be a data element that is encoded into a service request (e.g., as or in an HTTP header) to indicate the client device's sustainability preference. The sustainability flag can be used by the network node to select computing resources that meet the sustainability preference.

In additional embodiments, if the client device does not have a sufficient sustainability preference, the process 800 may generate a sustainability flag indicating an insufficient sustainability preference or refrain from generating a sustainability flag (block 830). The decision to generate a sustainability flag indicating an insufficient preference or to refrain from generating a sustainability flag can depend on the specific implementation of the process 800. If a sustainability flag is generated, it may indicate to the network node that the client device's sustainability preference is not a priority, allowing the network node to select computing resources based on other factors such as performance or cost.

In further embodiments, the process 800 may transmit a service request to a network node (block 840). The service request can include the sustainability flag (e.g., as or in an HTTP header) if one was generated. The network node can be a server (e.g., a load balancer), router, switch, or other device that is capable of receiving and forwarding the service request. The transmission process can include encoding the service request and the sustainability flag into a data packet and sending the data packet over a network to the network node.

In still more embodiments, the process 800 may receive at least one service response from one or more computing resources in a plurality of computing resources based on the service request (block 850). The service response can be generated by the computing resources that were selected to serve the service request based on the sustainability flag. The service response can include data, such as the results of a computation or the contents of a requested web page, that is sent back to the client device.

Although a specific embodiment for transmitting a service request based on a sustainability preference suitable for carrying out the various steps, processes, methods, and operations described herein is discussed with respect to FIG. 8, any of a variety of systems and/or processes may be utilized in accordance with embodiments of the disclosure. For example, the process may be implemented by a client device that uses a mobile application to send service requests over a wireless network. The elements depicted in FIG. 8 may also be interchangeable with other elements of FIGS. 1-7, 9, and 10 as required to realize a particularly desired embodiment.

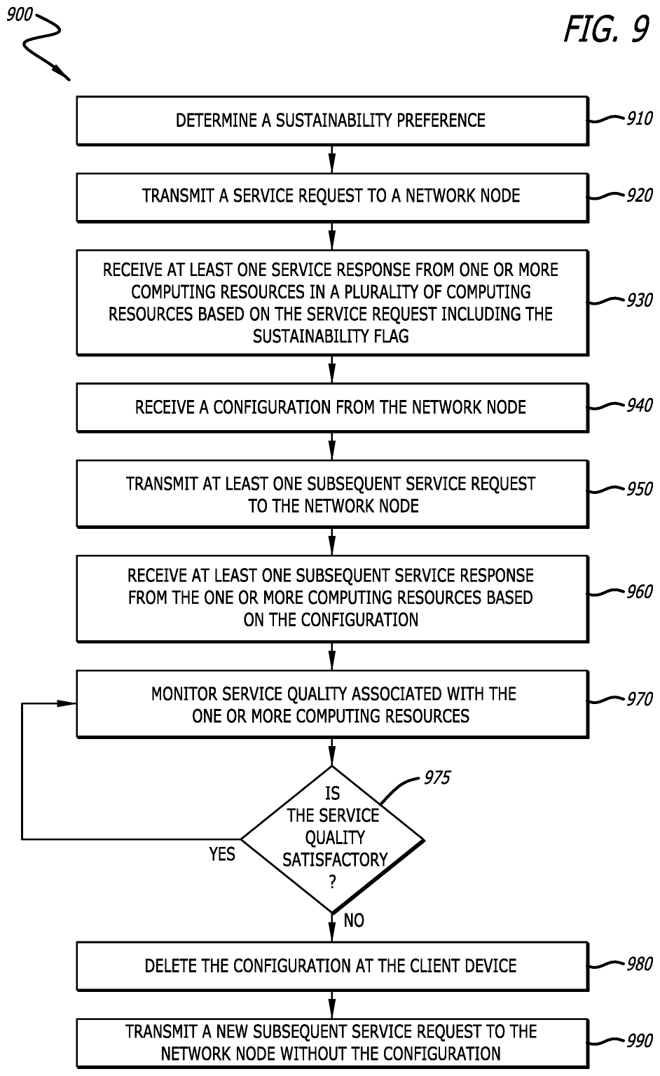

Referring to FIG. 9, a flowchart showing a process 900 for transmitting a service request based on a sustainability preference in a cloud environment in accordance with various embodiments of the disclosure is shown. In many embodiments, the process 900 may determine a sustainability preference (block 910). This may include analyzing user input, system settings, or other data to identify a preference for using computing resources that are powered by sustainable or renewable energy sources. The determination process can include interpreting the user input or system settings and translating them into a sustainability preference.

In a number of embodiments, the process 900 may transmit a service request to a network node (block 920). The service request can include a sustainability flag (e.g., as or in an HTTP header) that indicates the determined sustainability preference. The network node can be a server (e.g., a load balancer), router, switch, or other device that is capable of receiving and forwarding the service request.

In a variety of embodiments, the process 900 may receive at least one service response from one or more computing resources in a plurality of computing resources based on the service request including the sustainability flag (block 930). The service response can be generated by the computing resources that were selected to serve the service request based on the sustainability flag. The service response can include data, such as the results of a computation or the contents of a requested web page, that is sent back to the client device.

In some embodiments, the process 900 may receive a configuration from the network node (block 940). The configuration can include data about the selected computing resources, such as their addresses or IDs. In more embodiments, the configuration may be stored at the client device in a cookie.

In additional embodiments, the process 900 may transmit at least one subsequent service request to the network node (block 950). The subsequent service request can include the configuration received from the network node. The subsequent service request can also include a request for a specific service or data.

In further embodiments, the process 900 may receive at least one subsequent service response from the one or more computing resources based on the configuration (block 960). The subsequent service response can be generated by the computing resources that were selected to serve the subsequent service request based on the configuration. The subsequent service response can include data, such as the results of a computation or the contents of a requested web page, that is sent back to the client device.

In still more embodiments, the process 900 may monitor service quality associated with the one or more computing resources (block 970). The service quality can be evaluated based on various metrics such as response time, error rate, or throughput. The monitoring process can be performed continuously or at regular intervals to ensure that the service quality remains satisfactory.

In still further embodiments, the process 900 can determine if the service quality is satisfactory (block 975). In still additional embodiments, in response to the service quality being satisfactory, the process 900 can continue to monitor the service quality. However, in some more embodiments, when the service quality is not satisfactory, the process 900 can delete the configuration at the client device. The determination of whether the service quality is satisfactory can be based on a comparison of the service quality metrics with a threshold or criteria for satisfaction.

In certain embodiments, if the service quality is not satisfactory, the process 900 may delete the configuration at the client device (block 980). Deleting the configuration can include removing the configuration settings or parameters from the memory or storage of the client device. In yet more embodiments, deleting the configuration can include deleting the relevant cookie from the client device.

In still yet more embodiments, the process 900 may transmit a new subsequent service request to the network node without the configuration (block 990). The new subsequent service request can be generated without using the configuration that was deleted. Without the deleted configuration, the network node may reselect computing resources in order to serve the new subsequent service request, with or without consideration of another sustainability flag that may be provided by the client device.

Although a specific embodiment for transmitting a service request based on a sustainability preference suitable for carrying out the various steps, processes, methods, and operations described herein is discussed with respect to FIG. 9, any of a variety of systems and/or processes may be utilized in accordance with embodiments of the disclosure. For example, the process may be implemented by a client device that uses a specialized tool or application designed for managing sustainability preferences in a cloud computing environment. The elements depicted in FIG. 9 may also be interchangeable with other elements of FIGS. 1-8 and 10 as required to realize a particularly desired embodiment.

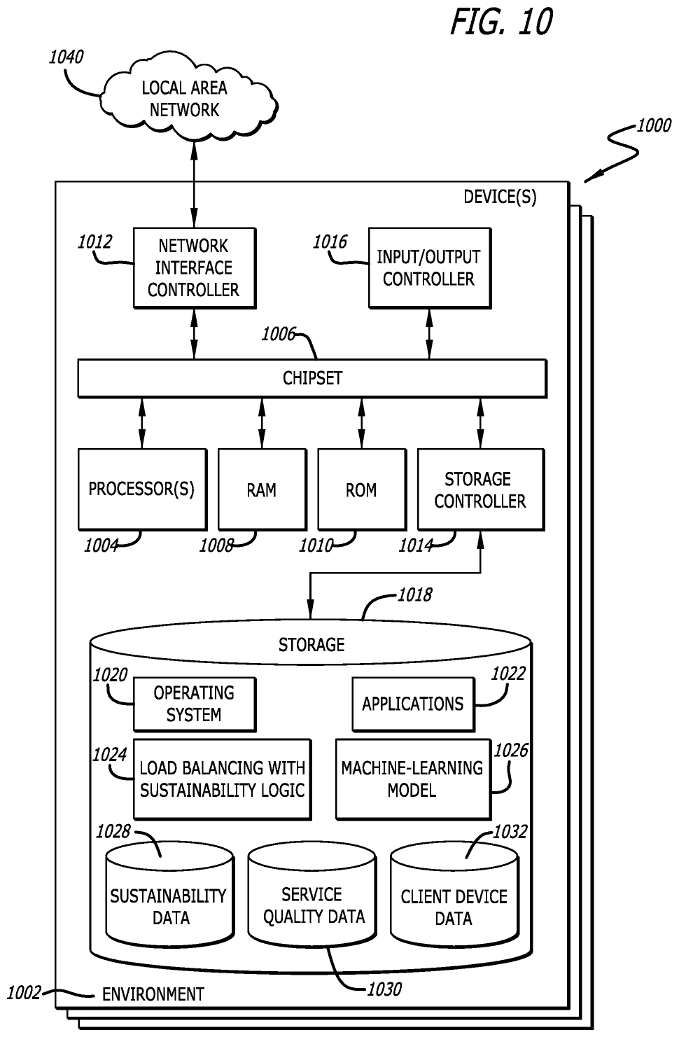

Referring to FIG. 10, a conceptual block diagram for one or more devices 1000 capable of executing components and logic for implementing the functionality and embodiments described above is shown. The embodiment of the conceptual block diagram depicted in FIG. 10 can illustrate a conventional server computer, workstation, desktop computer, laptop, tablet, network appliance, e-reader, smartphone, or other computing device, and can be utilized to execute any of the application and/or logic components presented herein. The device 1000 may, in some examples, correspond to physical devices or to virtual resources described herein.

In many embodiments, the device 1000 may include an environment 1002 such as a baseboard or “motherboard,” in physical embodiments that can be configured as a printed circuit board with a multitude of components or devices connected by way of a system bus or other electrical communication paths. Conceptually, in virtualized embodiments, the environment 1002 may be a virtual environment that encompasses and executes the remaining components and resources of the device 1000. In more embodiments, one or more processors 1004, such as, but not limited to, central processing units (“CPUs”) can be configured to operate in conjunction with a chipset 1006. The processor(s) 1004 can be standard programmable CPUs that perform arithmetic and logical operations necessary for the operation of the computer device 1000.

In additional embodiments, the processor(s) 1004 can perform one or more operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

In certain embodiments, the chipset 1006 may provide an interface between the processor(s) 1004 and the remainder of the components and devices within the environment 1002. The chipset 1006 can provide an interface to a random-access memory (“RAM”) 1008, which can be used as the main memory in the device 1000 in some embodiments. The chipset 1006 can further be configured to provide an interface to a computer-readable storage medium such as a read-only memory (“ROM”) 1010 or non-volatile RAM (“NVRAM”) for storing basic routines that can help with various tasks such as, but not limited to, starting up the device 1000 and/or transferring information between the various components and devices. The ROM 1010 or NVRAM can also store other application components necessary for the operation of the device 1000 in accordance with various embodiments described herein.

Different embodiments of the device 1000 can be configured to operate in a networked environment using logical connections to remote computing devices and computer systems through a network, such as the network 1040. The chipset 1006 can include functionality for providing network connectivity through a network interface card (“NIC”) 1012, which may comprise a gigabit Ethernet adapter or similar component. The NIC 1012 can be capable of connecting the device 1000 to other devices over the network 1040. It is contemplated that multiple NICs 1012 may be present in the device 1000, connecting the device to other types of networks and remote systems.

In further embodiments, the device 1000 can be connected to a storage 1018 that provides non-volatile storage for data accessible by the device 1000. The storage 1018 can, for example, store an operating system 1020, applications 1022, and sustainability data 1028, service quality data 1030, and client device data 1032, which are described in greater detail below. The storage 1018 can be connected to the environment 1002 through a storage controller 1014 connected to the chipset 1006. In certain embodiments, the storage 1018 can consist of one or more physical storage units. The storage controller 1014 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The device 1000 can store data within the storage 1018 by transforming the physical state of the physical storage units to reflect the information being stored. The specific transformation of physical state can depend on various factors. Examples of such factors can include, but are not limited to, the technology used to implement the physical storage units, whether the storage 1018 is characterized as primary or secondary storage, and the like.

For example, the device 1000 can store information within the storage 1018 by issuing instructions through the storage controller 1014 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit, or the like. Other transformations of physical media are possible without departing from the scope and spirit of the present description, with the foregoing examples provided only to facilitate this description. The device 1000 can further read or access information from the storage 1018 by detecting the physical states or characteristics of one or more particular locations within the physical storage units.

In addition to the storage 1018 described above, the device 1000 can have access to other computer-readable storage media to store and retrieve information, such as program modules, data structures, or other data. It should be appreciated by those skilled in the art that computer-readable storage media is any available media that provides for the non-transitory storage of data and that can be accessed by the device 1000. In some examples, the operations performed by a cloud computing network, and or any components included therein, may be supported by one or more devices similar to device 1000. Stated otherwise, some or all of the operations performed by the cloud computing network, and or any components included therein, may be performed by one or more computer devices 1000 operating in a cloud-based arrangement.

By way of example, and not limitation, computer-readable storage media can include volatile and non-volatile, removable, and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage 1018 can store an operating system 1020 utilized to control the operation of the device 1000. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage 1018 can store other system or application programs and data utilized by the device 1000.

In various embodiment, the storage 1018 or other computer-readable storage media is encoded with computer-executable instructions which, when loaded into the device 1000, may transform it from a general-purpose computing system into a special-purpose computer capable of implementing the embodiments described herein. These computer-executable instructions may be stored as application 1022 and transform the device 1000 by specifying how the processor(s) 1004 can transition between states, as described above. In some embodiments, the device 1000 has access to computer-readable storage media storing computer-executable instructions which, when executed by the device 1000, perform the various processes described above with regard to FIGS. 1-10. In more embodiments, the device 1000 can also include computer-readable storage media having instructions stored thereupon for performing any of the other computer-implemented operations described herein.

In still further embodiments, the device 1000 can also include one or more input/output controllers 1016 for receiving and processing input from a number of input devices, such as a keyboard, a mouse, a touchpad, a touch screen, an electronic stylus, or other type of input device. Similarly, an input/output controller 1016 can be configured to provide output to a display, such as a computer monitor, a flat panel display, a digital projector, a printer, or other type of output device. Those skilled in the art will recognize that the device 1000 might not include all of the components shown in FIG. 10, and can include other components that are not explicitly shown in FIG. 10, or might utilize an architecture completely different than that shown in FIG. 10.

As described above, the device 1000 may support a virtualization layer, such as one or more virtual resources executing on the computer device 1000. In some examples, the virtualization layer may be supported by a hypervisor that provides one or more virtual machines running on the computer device 1000 to perform functions described herein. The virtualization layer may generally support a virtual resource that performs at least a portion of the techniques described herein.

In many embodiments, the device 1000 can include a load balancing with sustainability logic 1024. The load balancing with sustainability logic 1024 may enhance the functionality of a network node by considering sustainability preferences in load balancing decisions. The load balancing with sustainability logic 1024 can receive service requests from client devices, which may include a sustainability flag, and can use the sustainability flag along with sustainability data associated with various computing resources to direct the service request to the most appropriate resources.

In a number of embodiments, the storage 1018 can include sustainability data 1028. The sustainability data 1028 may relate to the environmental impact metrics of various computing resources. The sustainability data 1028 can include details such as the energy efficiency of a resource, its net-zero compliance status, or the type of energy it uses (renewable or non-renewable).

In various embodiments, the storage 1018 can include service quality data 1030. The service quality data 1030 may pertain to the performance metrics of various computing resources. The service quality data 1030 can include data such as response time, error rate, throughput, and other performance indicators that reflect the efficiency and reliability of a resource.

In still more embodiments, the storage 1018 can include client device data 1032. The client device data 1032 may relate to the devices that are sending service requests to the network node. The client device data 1032 can include details such as the device type, operating system, network connection quality, and the sustainability preferences of the device or user.

Finally, in many embodiments, data may be processed into a format usable by a machine-learning model 1026 (e.g., feature vectors), and or other pre-processing techniques. The machine-learning (“ML”) model 1026 may be any type of ML model, such as supervised models, reinforcement models, and/or unsupervised models. The ML model 1026 may include one or more of linear regression models, logistic regression models, decision trees, Naïve Bayes models, neural networks, k-means cluster models, random forest models, and/or other types of ML models 1026. The ML model 1026 may be configured to analyze and predict the performance and sustainability metrics of various computing resources using historical data and real-time inputs.

Although the present disclosure has been described in certain specific aspects, many additional modifications and variations would be apparent to those skilled in the art. In particular, any of the various processes described above can be performed in alternative sequences and/or in parallel (on the same or on different computing devices) in order to achieve similar results in a manner that is more appropriate to the requirements of a specific application. It is therefore to be understood that the present disclosure can be practiced other than specifically described without departing from the scope and spirit of the present disclosure. Thus, embodiments of the present disclosure should be considered in all respects as illustrative and not restrictive. It will be evident to the person skilled in the art to freely combine several or all of the embodiments discussed here as deemed suitable for a specific application of the disclosure. Throughout this disclosure, terms like “advantageous”, “exemplary” or “example” indicate elements or dimensions which are particularly suitable (but not essential) to the disclosure or an embodiment thereof and may be modified wherever deemed suitable by the skilled person, except where expressly required. Accordingly, the scope of the disclosure should be determined not by the embodiments illustrated, but by the appended claims and their equivalents.

Any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims.

Moreover, no requirement exists for a system or method to address each and every problem sought to be resolved by the present disclosure, for solutions to such problems to be encompassed by the present claims. Furthermore, no element, component, or method step in the present disclosure is intended to be dedicated to the public regardless of whether the element, component, or method step is explicitly recited in the claims. Various changes and modifications in form, material, workpiece, and fabrication material detail can be made, without departing from the spirit and scope of the present disclosure, as set forth in the appended claims, as might be apparent to those of ordinary skill in the art, are also encompassed by the present disclosure.

What is claimed is:

1. A network node, comprising:
a processor;
at least one network interface controller configured to provide access to a network; and
a memory communicatively coupled to the processor, wherein the memory comprises a load balancing with sustainability logic that is configured to:
receive a service request from a client device, the service request including a sustainability flag;
identify sustainability data associated with a plurality of computing resources;
select one or more computing resources in the plurality of computing resources based on the sustainability flag and the identified sustainability data; and
direct the service request to be served by the selected one or more computing resources.

2. The network node of claim 1, wherein the sustainability flag is included in a message header of the service request.

3. The network node of claim 1, wherein the load balancing with sustainability logic is further configured to receive one or more updates for the sustainability data associated with the plurality of computing resources.

4. The network node of claim 1, wherein the load balancing with sustainability logic is further configured to:
generate a configuration for the client device, the configuration associating the client device with the selected one or more computing resources; and
transmit the configuration to the client device.

5. The network node of claim 4, wherein the configuration is associated with a cookie.

6. The network node of claim 4, wherein the load balancing with sustainability logic is further configured to:
receive at least one subsequent service request from the client device, the at least one subsequent service request being associated with the configuration; and
direct the at least one subsequent service request to be served by the selected one or more computing resources based on the configuration.

7. The network node of claim 1, wherein each of the plurality of computing resources corresponds to at least one of an availability zone (AZ), a point of presence (POP), or a network device.

8. The network node of claim 1, wherein the sustainability data includes at least one environmental impact metric for each of the plurality of computing resources.

9. The network node of claim 1, wherein the sustainability flag indicates a presence or an absence of a sustainability preference of the client device.

10. The network node of claim 9, wherein the one or more computing resources are selected based on at least one environmental impact metric for the selected one or more computing resources being less than a first threshold in response to the sustainability flag indicating the presence of the sustainability preference of the client device.

11. The network node of claim 1, wherein the sustainability flag indicates a degree of a sustainability preference of the client device.

12. The network node of claim 11, wherein the one or more computing resources are selected based on at least one environmental impact metric for the selected one or more computing resources being less than a first threshold in response to the degree of the sustainability preference of the client device as indicated by the sustainability flag being greater than a second threshold.

13. A client device, comprising:
a processor;
at least one network interface controller configured to provide access to a network; and
a memory communicatively coupled to the processor, wherein the memory comprises a sustainability logic that is configured to:
transmit a service request to a network node, the service request including a sustainability flag; and
receive at least one service response from one or more computing resources in a plurality of computing resources based on the service request including the sustainability flag.

14. The client device of claim 13, wherein the sustainability flag is included in a message header of the service request.

15. The client device of claim 13, wherein the sustainability logic is further configured to receive a configuration from the network node, the configuration associating the client device with the one or more computing resources.

16. The client device of claim 15, wherein the configuration is associated with a cookie.

17. The client device of claim 15, wherein the sustainability logic is further configured to:
transmit at least one subsequent service request to the network node, the at least one subsequent service request being associated with the configuration; and
receive at least one subsequent service response from the one or more computing resources based on the configuration.

18. The client device of claim 15, wherein the sustainability logic is further configured to delete the configuration at the client device in response to a service quality associated with the one or more computing resources being less than a threshold.

19. The client device of claim 13, wherein the sustainability flag indicates at least one of a presence, an absence, or a degree of a sustainability preference of the client device.

20. A method for load balancing with sustainability, comprising:
receiving a service request from a client device, the service request including a sustainability flag;
identifying sustainability data associated with a plurality of computing resources;
selecting one or more computing resources in the plurality of computing resources based on the sustainability flag and the identified sustainability data; and
directing the service request to be served by the selected one or more computing resources.
